(19) United States
(12) Patent Application Publication
(10) Pub. No.: US 2003/0184264 A1
(43) Pub. Date: Oct. 2, 2003

(54) Apparatus and method for counteracting self discharge in a storage battery

(76) Inventor: Kevin I. Bertness, Batavia, IL (US)

Correspondence Address: Alan G. Rego, Westman, Champlin & Kelly, International Centre, Suite 1600, 900 Second Avenue South, Minneapolis, MN, 55402-3319, US

(21) Appl. No.: 10/109,734

(22) Filed: Mar. 28, 2002

(51) Int. Cl. H02J 7/00

(52) U.S. Cl. 320/137

(57) ABSTRACT

A system for counteracting self-discharge in a storage battery is provided. The system includes a charge supply battery that provides a supply voltage. The system also includes a DC-DC converter circuit that has an input that electrically couples to the charge supply battery and an output that electrically couples to terminals of the storage battery. The DC-DC converter circuit provides a charging voltage at the output that has a magnitude greater than a magnitude of the supply voltage.

### BACKGROUND OF THE INVENTION

The present invention relates to storage batteries. More specifically, the present invention relates to a system for counteracting self-discharge in a storage battery.

Chemical batteries which create electricity from chemical reactions have been known for many years. Such batteries are becoming increasingly important and have found uses throughout industry. These uses include automobiles, UPS systems, etc.

One of the most commonly used chemical batteries are lead acid storage batteries. A lead acid battery cell includes positive and negative lead plates of slightly different composition in a dilute sulfuric acid electrolyte. As the cell discharges, sulfur molecules from the electrolyte bond with the lead plates, releasing excess electrons. As the cell charges, excess electrons bond with sulfur compounds forcing the sulfur molecules back into the sulfuric acid solution.

When a lead acid battery is left idle for a substantial period of time without being recharged, a build-up of sulfur molecules on the battery plates takes place due to self-discharge of the battery. This formation of sulfur on the battery plates is called sulfation. Sulfation hardens the battery plates, reducing and eventually destroying the ability of the battery to generate charge. In lead acid batteries employing thin film positive and negative plates, relatively rapid hardening of the plates due to sulfation occurs because the plates are ultra-thin films.

One prior art technique used to counteract self-discharge in lead acid batteries involves connecting an alkaline battery (or multiple series connected alkaline batteries) in parallel with the lead acid battery when it is left idle. The alkaline battery provides a charging voltage that counteracts self-discharge in the lead acid storage battery. However, when a relatively small drop in the capacity of the alkaline battery takes place, the charging voltage drops below the rated voltage of the lead acid storage battery resulting in self-discharge and sulfation in the lead acid battery. Thus, to prevent self-discharge using this technique, alkaline batteries have to be replaced frequently because they are unsuitable even after a small loss of capacity. This technique for preventing self-discharge in lead acid batteries is inconvenient and costly.

### SUMMARY OF THE INVENTION

A system for counteracting self-discharge in a storage battery is provided. The system includes a charge supply battery that provides a supply voltage. The system also includes a DC-DC converter circuit that has an input that electrically couples to the charge supply battery and an output that electrically couples to terminals of the storage battery. The DC-DC converter circuit provides a charging voltage at the output that has a magnitude greater than a magnitude of the supply voltage.

### BRIEF DESCRIPTION OF THE DRAWINGS

FIG. 1 is a simplified block diagram of an apparatus for counteracting self-discharge in a storage battery in accordance with an embodiment of the present invention.

FIG. 2 is a simplified block diagram showing a jump-start booster pack in accordance with an embodiment of the present invention.

FIGS. 3-1 and 3-2 illustrate embodiments of an apparatus for providing energy to a vehicle battery.

FIG. 4 illustrates a DC-DC converter circuit which is used with the present invention.

### DETAILED DESCRIPTION OF THE PREFERRED EMBODIMENTS

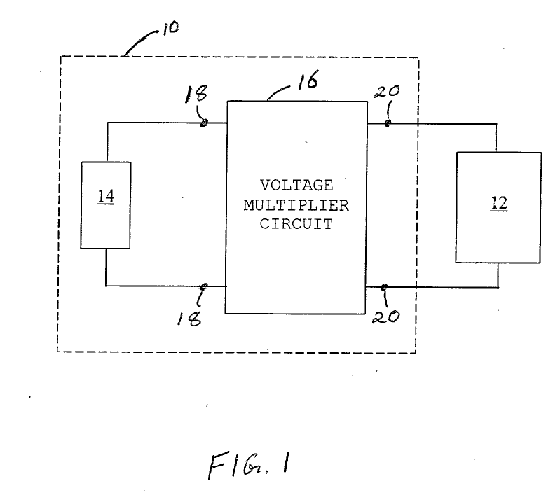

FIG. 1 is a simplified block diagram of a self discharge prevention apparatus 10 for counteracting self discharge in a rechargeable storage battery 12 in accordance with an embodiment of the present invention. Self-discharge prevention apparatus 10 includes a charge supply battery 14 and a DC-DC converter circuit 16. Charge supply battery 14 provides charging energy necessary to counteract self-discharge of battery 12. Charge supply battery 14 may be, for example, one or more commercially available “D” alkaline batteries. If multiple batteries are employed, they are connected in series with each other. DC-DC converter circuit 16 may be any charge pump or multiplier circuit known or yet to be discovered in the art. Such charge pump circuits typically include a charge storage device, such as a capacitor and/or an inductor, that can be charged individually by a supply voltage and form a series connected chain to provide a multiplied voltage output.

Apparatus 10 is electrically coupled to storage battery 12 when it is left idle. Apparatus 10 can be a physical component of battery 12 or can be connected to battery 12 during a period of storage such as after manufacture. As can be seen in FIG. 1, charge supply battery 14 is connected to an input, shown by nodes 18, of DC-DC converter circuit 16 and storage battery 12 is coupled to an output, shown by nodes 20, of DC-DC converter circuit 16. DC-DC converter circuit 16 can provide a charging voltage as a function of the supply voltage provided by charge supply battery 14. The charging voltage provided has a magnitude sufficient to prevent self-discharge of storage battery 12. In some embodiments, the charging voltage has a magnitude that is greater than or equal to the rated voltage of storage battery 12. DC-DC converter circuit 16 can maintain the charging voltage magnitude at a level sufficient to prevent self-discharge of storage battery 12 when the magnitude of the supply voltage decreases due to a reduction in the capacity of charge supply battery 14. Thus, by employing DC-DC converter circuit 16, the present invention takes full advantage of the life span of charge supply battery 14, which can be employed until the end of its useful life. The useful life of a battery is over when its voltage drops below a certain threshold, which is usually about 60% of the rated battery voltage in an alkaline battery.

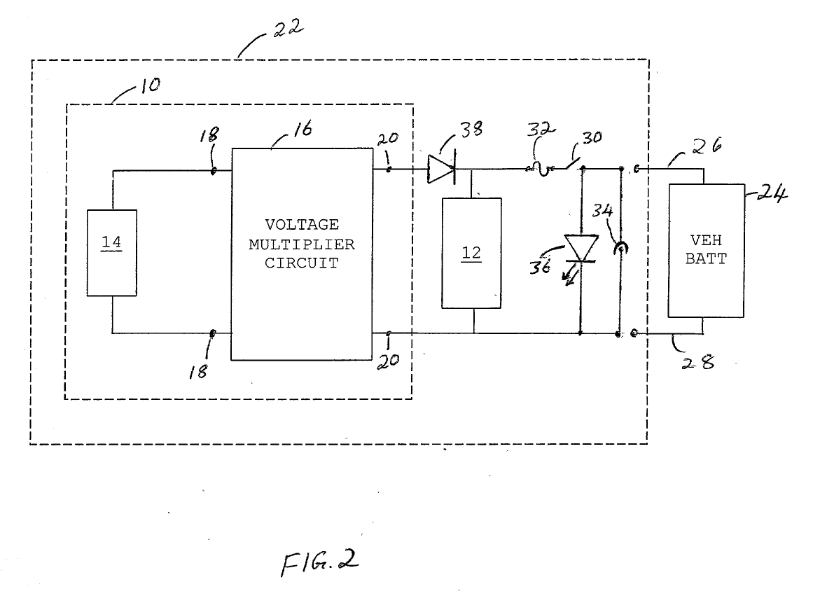

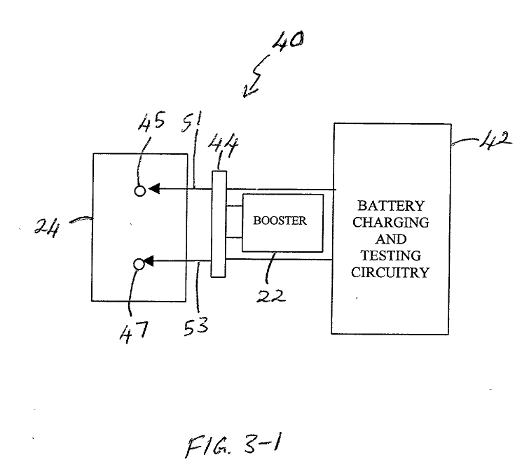

The present invention is particularly useful in preventing self-discharge of an internal booster battery employed in a jump-start booster pack, which typically remains idle in a vehicle until such time as it is necessary to be used. Such a jump-start booster pack is described in connection with FIG. 2 below.

FIG. 2 is a very simplified block diagram showing a jump-start booster pack 22 in accordance with an embodiment of the present invention. Jump-start booster pack 22 includes, as its principal components, self-discharge prevention apparatus 10 and storage battery or internal booster battery 12. Internal booster battery 12 has substantially equal terminal voltage to the rated voltage of vehicle battery 24 to be boosted. As can be seen in FIG. 2, Cables 26 and 28 are schematically indicated, and are provided to connect booster battery 12 to vehicle battery 24 to be boosted. A switch 30 is provided in series with either cable 26 or 28 (only one switch, at one side of the circuit is required) so as to provide a connection between booster battery 12 and vehicle battery 24, after the cables 26 and 28 have been put in place. A fuse 32 is provided in series with the switch 30. Alternatively, fuse 32 and switch 30 could be provided as a single entity, such as a circuit breaker switch. There is also provided protection against inadvertent wrong polarity connections being made.

The capacity of booster battery 12 is relatively small compared with the capacity of the vehicle battery 24, and is generally in the range of from about 1% to less than 25% of the ampere-hour rated capacity of the vehicle battery 24. In embodiments of the present invention, jump-start booster pack 22 includes a handle (not shown) and is transportable on wheels (not shown). In some embodiments, jump-start booster pack 22 is portable and may generally have a weight of about 3.0 Kg to about 5.0 Kg. A preferred internal booster battery for a portable embodiment of booster pack 22 is a Thin Metal Film (TMF) lead acid battery. These batteries have very high cranking current, almost no reserve capacity, and very small size and weight. Self-discharge prevention apparatus 10, employed in booster pack 22, prevents sulfation, which occurs relatively rapidly in TMF lead acid batteries.

A lamp 36, such as a LED, may be provided across the terminals of the booster battery 12 at a position on a side of switch 30 which is remote from booster battery 12. Therefore, when booster battery 12 is connected to vehicle battery 24, and the switch 30 is closed, lamp 36 will be illuminated. Lamp 36 may be Zener operated in such a manner that it will only illuminate when it is connected across the voltage of the booster battery 12, but not across a substantially depleted terminal voltage of the vehicle battery 24.

As mentioned above, apparatus 10 is capable of preventing self-discharge of internal booster battery 12. Further, apparatus 10 can provide a trickle charge to booster battery 12 to recharge it over a relatively long period of time after a jump start is performed. However, to relatively rapidly charge internal booster battery 12 just after a jump-start, embodiments of the present invention include battery charging circuitry, discussed further below in connection with FIGS. 3-1 and 3-2. In some embodiments of the present invention, internal booster battery 12 may be charged by vehicle battery 24 or a vehicle alternator system (not shown). A suitable mode selection switch (not shown in FIG. 2) is typically included to select a particular charging mode for recharging internal booster battery 12. A diode 38, may be included to prevent backflow of energy from internal booster battery 12 when it is being charged. Connecting the booster battery 12 to the vehicle battery 24 may simply involve plugging wires which are also permanently connected to the terminals of the booster battery 12 and to a cigarette lighter plug into a cigarette lighter socket.

In some embodiments of the present invention, apparatus 22 can function as a portable power pack. In such embodiments, a connection or socket means, shown schematically at 34, which is essentially identical to a cigarette lighter socket may be connected across the terminals of the booster battery 12. Battery or low voltage operated devices such as emergency lamps, search lamps, a vacuum cleaner, etc., may be powered for a short term from the booster battery 12 by being connected from their own plug to the cigarette lighter socket arrangement 34.

To operate jump-start booster pack 22 to provide sufficient starting energy to vehicle battery 24, the appropriate connections are made as discussed above. In actuality, a pair of cables may be provided having clamps at one end of each cable to be connected to the terminals of the vehicle battery 24; and having a polarized plug at the other end of each cable for connection to a provided socket in jump-start booster pack 22. Then, after the cables are connected to the vehicle battery 24 and to the socket connection for the booster battery 12, the switch 30 is then closed and energy will flow from the booster battery 12 to the vehicle battery 24. In the usual circumstances, the voltage of the booster battery 12 is approximately 12 volts, and the rated voltage of the vehicle battery 24 is also 12 volts although the actual terminal voltage of the vehicle battery may have reduced to as little as 9 or even 6 volts. In any event, after connection of the booster battery 12 to the vehicle battery 24, the voltage of the parallel connected batteries rises to a level which is necessary to initiate and sustain spark ignition during cranking.

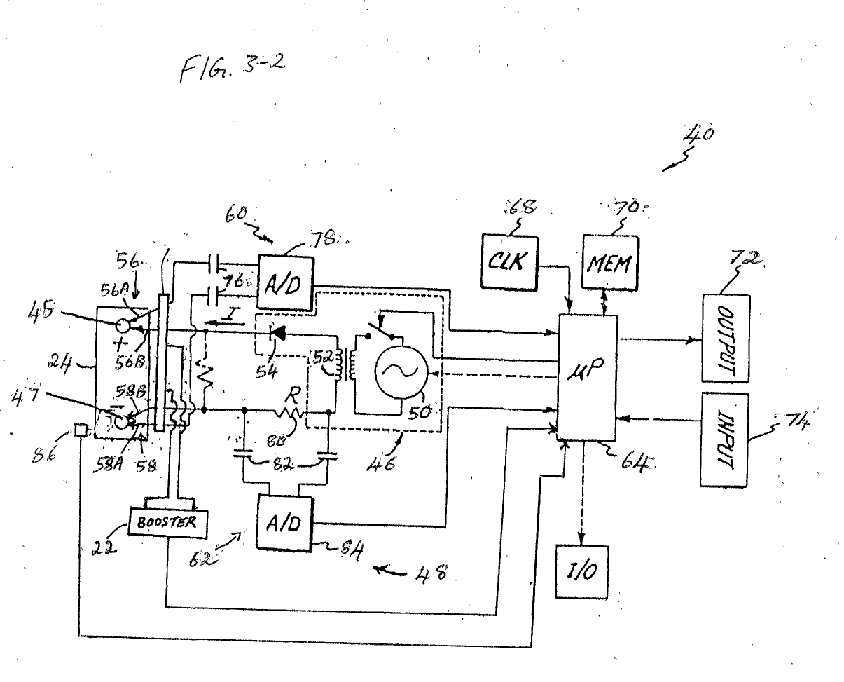

FIG. 3-1 is a very simplified block diagram of a jump-start booster pack with integrated battery charging and testing circuitry in accordance with an embodiment of the present invention. System 40 is shown coupled to a vehicle battery 24. System 40 includes battery charging and testing circuitry 42, jump-start booster pack 22, described above in connection with FIG. 2, and mode selection switch 44. System 40 couples to battery contacts 45 and 47 through electrical connections 51 and 53, respectively. Details and components of a battery charging and testing circuitry 42 are provided in the description of FIG. 3-2 below. Mode selection switch 44 can be set in different positions, with each position corresponding to a different mode in which system 40 operates. For example, system 40 can be set to operate in modes such as “charge vehicle battery”, “charge booster battery”, “charge vehicle battery and booster battery”, “jump-start vehicle battery”, “test vehicle battery”, “test booster battery”, “preserve booster battery”, etc.

FIG. 3-2 is a simplified block diagram of an embodiment of system 40 showing components of charging and testing circuitry 42. System 40 is shown coupled to vehicle battery 12. System 40 includes battery charger circuitry 46, battery test circuitry 48 and a jump-start booster pack 22. Battery charge circuitry 46 generally includes AC source 50, transformer 52 and rectifier 54. System 40 couples to vehicle battery 12 through electrical connection 56 which couples to the positive battery contact 45 and electrical connection 58 which couples to the negative battery contact 47. Mode selection switch 44 can be set in the different positions mentioned above in connection with FIG. 3-1. In one preferred embodiment, a four point (or Kelvin) connection technique is used in which battery charge circuitry 46 couples to battery 24 through electrical connections 56A and 58A while battery testing circuitry 48 couples to vehicle battery 24 through electrical connections 56B and 58B.

Battery testing circuitry 48 includes voltage measurement circuitry 60 and current measurement circuitry 62 which provide outputs to microprocessor 64. Microprocessor 64 also couples to a system clock 68 and memory 70 which is used to store information and programming instructions. In the embodiment of the invention shown in FIG. 3-2, microprocessor 64 also couples to booster pack 22, user output circuitry 72 and user input circuitry 74.

Voltage measurement circuitry 60 includes capacitors 76 which couple analog to digital converter 78 to vehicle battery 24 thorough electrical connections 56B and 58B. Any type of coupling mechanism may be used for element 76 and capacitors are merely shown as one preferred embodiment. Further, the device may also couple to DC signals. Current measurement circuitry 62 includes a shunt resistor (R) 80 and coupling capacitors 82. Shunt resistor 80 is coupled in series with battery charging circuitry 46. Other current measurement techniques are within the scope of the invention including Hall-Effect sensors, magnetic or inductive coupling, etc. An analog to digital converter 84 is connected across shunt resistor 80 by capacitors 82 such that the voltage provided to analog to digital converter 84 is proportional to a current I flowing through vehicle battery 24 due to charging circuitry 46. Analog to digital converter 84 provides a digitized output representative of this current to microprocessor 64.

During operation in vehicle battery charging mode, AC source 50 is coupled to vehicle battery 24 through transformer 52 and rectifier 54. Rectifier 54 provides half wave rectification such that current I has a non-zero DC value. Of course, full wave rectification or other AC sources may also be used. Analog to digital converter 84 provides a digitized output to microprocessor 64 which is representative of current I flowing through vehicle battery 24. Similarly, analog to digital converter 78 provides a digitized output representative of the voltage across the positive and negative terminals of vehicle battery 24. Analog to digital converters 78 and 84 are capacitively coupled to vehicle battery 24 such that they measure the AC components of the charging signal.

Microprocessor 64 determines the conductance of vehicle battery 24 based upon the digitized current and voltage information provided by analog to digital converters 84 and 78, respectively. Microprocessor 64 calculates the conductance of vehicle battery 24 as follows:

$$Conductance = G = \frac{I}{V} \qquad Eq . 1$$

where I is the AC charging current and V is the AC charging voltage across vehicle battery 24. The battery conductance is used to monitor charging of vehicle battery 24. It has been discovered that as a battery is charged the conductance of the battery rises which can be used as feedback to the charger. This rise in conductance can be monitored in microprocessor 64 to determine when the battery has been fully charged. Conductance can be correlated to a condition of vehicle battery 24 which can be used as a basis for comparison of the battery against a battery rating, such as the Cold Cranking Amp (CCA) rating of the battery. A temperature sensor 86 can be thermally coupled to battery 24 and used to compensate battery measurements. Temperature readings can be stored in memory 70 for later retrieval.

In accordance with the present invention, the internal booster battery 12 of booster pack 22 can also be charged and tested by battery charging and testing circuitry 42 in a manner similar to that described for charging and testing vehicle battery 24. In embodiments of the present invention, vehicle battery 24 can also be charged by booster battery 12. Results of tests performed on internal booster battery 12 and vehicle battery 24 may be displayed on a suitable device (not shown) that can couple to microprocessor 64.

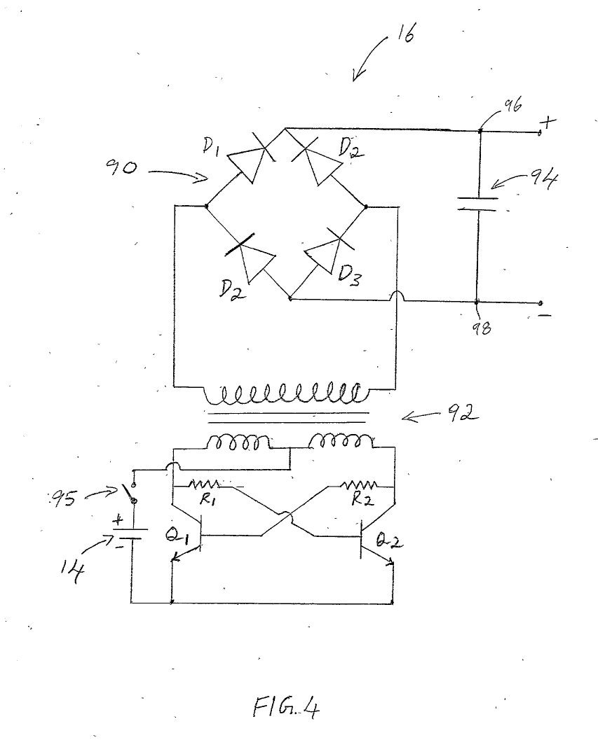

FIG. 4 illustrates a DC-DC converter circuit 16 which is used with the present invention. DC-DC converter circuit 16 includes two transistors Q1 and Q2, two resistors R1 and R2, a transformer 92, a bridge rectifier 90 including four diodes D1, D2, D3 and D4 and a capacitor 94. Charge supply battery 14, which provides an input voltage or supply voltage, is coupled to the primary side of transformer 92. An output voltage or changing voltage having a magnitude greater than the magnitude of the supply voltage is obtained across capacitor 94 on the secondary side of transformer 92.

In operation, when switch 95 is closed, power is applied to transistors Q1 and Q2 from battery 14. Transistors Q1 and Q2 drive the transformer primary with the base drive for each transistor coming from the collector of the other transistor. When power is applied, suppose transistor Q1 turns on a few nanoseconds faster than transistor Q2, then the collector voltage of transistor Q1 drops, shutting off transistor Q2, and collector voltage of transistor Q2 rises causing a greater collector current to flow through transistor Q1. The collector voltage of transistor Q1 drops further due to the inductive reactance of the primary coil of transformer 92.

As current flows through the primary winding of transformer 92, a voltage is induced in the transformer secondary winding by the expanding magnetic field in the transformer core. At a certain point, the magnetic field stops expanding, because either the transistor Q1 has reached the maximum collector current it can pass, or because the transformer core has reached the maximum magnetic field it can hold. In either case, the inductive reactance of the transformer primary drops, causing the voltage on the collector of transistor Q1 to rise. Since the collector of transistor Q1 drives the base of transistor Q2, Q2 turns on, which in turn shuts off transistor Q1. Now current flows in the opposite direction through the primary winding, causing the magnetic field in the core to reverse itself, which induces an opposite voltage in the secondary which continues until the field stops expanding and the process switches again. Bridge rectifier 90 ensures that the voltage across capacitor 94 always has the same polarity (positive at node 96 and negative at node 98). As mentioned above, transformer 92 is configured to provide a secondary voltage that is greater than the primary voltage. Thus, circuit 16 boosts the input voltage provided by battery 14. The boosted voltage across capacitor 94 is the changing voltage applied to storage battery 12 (FIG. 1).

Although the present invention has been described with reference to preferred embodiments, workers skilled in the art will recognize that changes may be made in form and detail without departing from the spirit and scope of the invention. It should be understood that the term “vehicle” not only includes cars and trucks, but can be equally applied to such installations as motors for boats, motorcycles, snowmobiles, farm tractors, etc. In general, storage battery 12, that is protected from self-discharge using the self-discharge prevention technique of the present invention, consists of a plurality of individual storage cells connected in series. Typically, each cell has a voltage potential of about 2.1 volts. By connecting the cells in series, the voltage of the individual cells are added in a cumulative manner. Thus, storage battery 12 may be a 6-cell battery (12.6V), a 12-cell battery (25.2V), an 18-cell battery (42V), a 24-cell battery (50.4V), etc. The self-discharge prevention technique of the present invention is applicable for the preservation of any type of battery that is prone to self-discharge. In embodiments of the present invention, charge supply battery 14 may be one or more “AA” alkaline batteries or one or more “C” alkaline batteries. In some embodiments, the “amp-hour” capacity of the charge supply battery is greater than the “amp-hour” capacity or rechargeable storage battery 12. In such embodiments, charge supply battery 14 is capable of recharging storage battery 12.

What is claimed is:

1. An apparatus for counteracting self discharge in a storage battery, comprising:
a charge supply battery configured to provide a supply voltage; and
a DC-DC converter circuit having an input configured to electrically couple to the charge supply battery and an output configured to electrically couple to terminals of the storage battery;
wherein the DC-DC converter circuit is configured to provide a charging voltage at the output having a magnitude greater than a magnitude of the supply voltage.

2. The apparatus of claim 1 wherein the DC-DC converter circuit comprises a transformer configured to step up the supply voltage.

3. The apparatus of claim 2 wherein the DC-DC converter further comprises a bridge rectifier circuit configured to provide rectification of the stepped up supply voltage provided by the transformer.

4. The apparatus of claim 1 wherein the DC-DC converter circuit includes a transistor.

5. The apparatus of claim 1 wherein the DC-DC converter circuit includes a charge storage device.

6. The apparatus of claim 5 wherein the charge storage device is a capacitor.

7. The apparatus of claim 1 wherein the charge supply battery is a single cell.

8. The apparatus of claim 1 wherein the charge supply battery includes a plurality of cells.

9. The apparatus of claim 8 wherein the plurality of cells is two cells.

10. The apparatus of claim 1 wherein the charge supply battery is a “D” cell alkaline battery.

11. The apparatus of claim 1 wherein the charge supply battery includes a plurality of “D” cell alkaline batteries.

12. The apparatus of claim 11 wherein the plurality of “D” cell alkaline batteries is two “D” cell alkaline batteries.

13. The apparatus of claim 1 wherein the charge supply battery is a “AA” alkaline battery.

14. The apparatus of claim 1 wherein the charge supply battery includes a plurality of “AA” alkaline batteries.

15. The apparatus of claim 14 wherein the plurality of “AA” alkaline batteries is two “AA” alkaline batteries.

16. The apparatus of claim 1 wherein the charge supply battery is a “C” cell alkaline battery.

17. The apparatus of claim 1 wherein the charge supply battery includes a plurality of “C” cell alkaline batteries.

18. The apparatus of claim 1 wherein the plurality of “C” cell alkaline batteries is two “C” cell alkaline batteries.

19. The apparatus of claim 1 configured to counteract self-discharge in a 6-cell storage battery.

20. The apparatus of claim 1 configured to counteract self-discharge in a 12-cell storage battery.

21. The apparatus of claim 1 configured to counteract self-discharge in an 18-cell storage battery.

22. The apparatus of claim 1 configured to counteract self-discharge in a 24-cell storage battery.

23. A jump-start booster pack, comprising:
a booster battery configured to provide starting energy to a vehicle;
a charge supply battery configured to provide a supply voltage; and
a DC-DC converter circuit having an input electrically coupled to the charge supply battery and an output electrically coupled to the booster battery;
wherein the DC-DC converter circuit is configured to provide a charging voltage at the output having a magnitude greater than a magnitude of the supply voltage.

24. The apparatus of claim 23 wherein the booster battery is a Thin Metal Film lead acid battery.

25. The apparatus of claim 23 wherein the charge supply battery is a single cell.

26. The apparatus of claim 26 wherein the charge supply battery includes a plurality of cells.

27. The apparatus of claim 23 wherein the plurality of cells is two cells.

28. The apparatus of claim 23 wherein the charge supply battery is a “D” cell alkaline battery.

29. The apparatus of claim 23 wherein the charge supply battery includes a plurality of “D” cell alkaline batteries.

30. The apparatus of claim 29 wherein the plurality of “D” cell alkaline batteries is two “D” cell alkaline batteries.

31. The apparatus of claim 23 wherein the charge supply battery is a “AA” alkaline battery.

32. The apparatus of claim 23 wherein the charge supply battery includes a plurality of “AA” alkaline batteries.

33. The apparatus of claim 32 wherein the plurality of “AA” alkaline batteries is two “AA” alkaline batteries.

34. The apparatus of claim 23 wherein the charge supply battery is a “C” cell alkaline battery.

35. The apparatus of claim 23 wherein the charge supply battery includes a plurality of “C” cell alkaline batteries.

36. The apparatus of claim 36 wherein the plurality of “C” cell alkaline batteries is two “C” cell alkaline batteries.

37. The apparatus of claim 23 further comprising battery charging circuitry configured to charge a vehicle battery.

38. The apparatus of claim 37 wherein the battery charging circuitry is further configured to charge the booster battery.

39. The apparatus of claim 37 where the battery charging circuitry is coupled to the vehicle battery through a four point Kelvin connection.

40. The apparatus of claim 23 further comprising battery testing circuitry configured to test a vehicle battery.

41. The apparatus of claim 40 wherein the battery testing circuitry is further configured to test the booster battery.

42. The apparatus of claim 40 where the battery testing circuitry is coupled to the vehicle battery through a four point Kelvin connection.

43. A method for counteracting self discharge in a storage battery, comprising:
providing a supply voltage from a charge supply battery; and
providing a charging voltage to the storage battery as a function of the supply voltage, with the charging voltage having a magnitude greater than a magnitude of the supply voltage.

44. The method of claim 43 wherein providing the charging voltage is carried out by a DC-DC converter circuit.

45. The method of claim 44 wherein the DC-DC converter circuit comprises a transformer configured to step up the supply voltage.

46. The method of claim 45 wherein the DC-DC converter further comprises a bridge rectifier circuit configured to provide rectification of the stepped up supply voltage provided by the transformer.

47. The method of claim 44 wherein the DC-DC converter circuit includes a transistor.

48. The method of claim 44 wherein the DC-DC converter circuit includes a charge storage device.

49. The method of claim 48 wherein the charge storage device is a capacitor.

50. The method of claim 43 wherein the charge supply battery is a single cell.

51. The apparatus of claim 43 wherein the charge supply battery includes a plurality of cells.

52. The apparatus of claim 51 wherein the plurality of cells is two cells.

53. The method of claim 43 wherein the charge supply battery is a “D” cell alkaline battery.

54. The apparatus of claim 43 wherein the charge supply battery includes a plurality of “D” cell alkaline batteries.

55. The apparatus of claim 54 wherein the plurality of “D” cell alkaline batteries is two “D” cell alkaline batteries.

56. The apparatus of claim 43 wherein the charge supply battery is a “AA” alkaline battery.

57. The apparatus of claim 43 wherein the charge supply battery includes a plurality of “AA” alkaline batteries.

58. The apparatus of claim 57 wherein the plurality of “AA” alkaline batteries is two “AA” alkaline batteries.

59. The apparatus of claim 43 wherein the charge supply battery is a “C” cell alkaline battery.

60. The apparatus of claim 43 wherein the charge supply battery includes a plurality of “C” cell alkaline batteries.

61. The apparatus of claim 60 wherein the plurality of “C” cell alkaline batteries is two “C” cell alkaline batteries.

62. The method of claim 43 employed to counteract self-discharge in a 6-cell storage battery.

63. The method of claim 43 employed to counteract self-discharge in a 12-cell storage battery.

64. The method of claim 43 employed to counteract self-discharge in an 18-cell storage battery.

65. The method of claim 43 employed to counteract self-discharge in a 24-cell battery.

66. A method of making a jump-start booster pack, comprising:
providing a booster battery configured to provide starting energy to a vehicle;
providing a charge supply battery configured to provide a supply voltage; and
providing a DC-DC converter circuit having an input electrically coupled to the charge supply battery and an output electrically coupled to the booster battery;
wherein the DC-DC converter circuit is configured to provide a charging voltage at the output having a magnitude greater than a magnitude of the supply voltage.

67. The method of claim 66 wherein providing the booster battery comprises providing a Thin Metal Film lead acid battery.

68. The method of claim 66 wherein providing the charge supply comprises providing a single cell battery.

69. The method of claim 66 wherein providing the charge supply battery comprises providing a “D” cell alkaline battery.

70. The method of claim 66 further comprising providing battery charging circuitry configured to charge a vehicle battery.

71. The method of claim 70 wherein the battery charging circuitry is further configured to charge the booster battery.

72. The method of claim 70 further comprising coupling the battery charging circuitry to the vehicle battery through a four point Kelvin connection.

73. The method of claim 66 further comprising providing battery testing circuitry configured to test a vehicle battery.

74. The method of claim 73 wherein the battery testing circuitry is further configured to test the booster battery.

75. The method of claim 73 further comprising coupling the battery testing circuitry to the vehicle battery through a four point Kelvin connection.
